(19) United States
(12) Patent Application Publication
(10) Pub. No.: US 2017/0110308 A1
(43) Pub. Date: Apr. 20, 2017

(54) Inert Atmospheric Solids Analysis Probe System

(71) Applicant: Advion Inc., Ithaca, NY (US)

(72) Inventors: Philippe Weis, Reuland (LU); Anke Schaub, Umkirch (DE); Ingo Krossing, Freiburg (DE)

(21) Appl. No.: 15/297,851

(22) Filed: Oct. 19, 2016

Related U.S. Application Data
(60) Provisional application No. 62/243,881, filed on Oct. 20, 2015.

(51) Int. Cl. H01J 49/04; H01J 49/00

(52) U.S. Cl. CPC H01J 49/0459; H01J 49/0495; H01J 49/0031; H01J 49/0404

(57) ABSTRACT

Systems and methods for ionization of a sample and mass separation of the ions by a mass spectrometer are disclosed herein.

### CROSS-REFERENCE TO RELATED APPLICATIONS

This application claims the benefit of priority to U.S. Provisional Application No. 62/243,881, filed on Oct. 20, 2015, which is incorporated herein by reference.

### TECHNICAL FIELD

This disclosure relates to ionization systems.

### BACKGROUND

Probes are used to introduce samples into ionization systems of a mass spectrometer to permit ionization and analysis of the sample. In particular, an atmospheric solids analysis probe can be used to direct analysis of volatile and semi-volatile, solid and liquid samples using atmospheric pressure ionization. In order to introduce the sample into the ionization system without contamination, a vacuum gas manifold or such as a Schlenk line is generally implemented to remove other constituents from the inert gas line. Schlenk lines can be used for manipulating air sensitive compounds. The vacuum created by such a line is generally used to remove the last traces of solvent or other unwanted components from a sample. However, the vacuum gas manifolds associated with such systems often have many ports and lines.

### SUMMARY

This disclosure describes probe systems and methods for ionization of a sample and mass separation of the ions by a mass spectrometer.

Some ionization sampling systems include a probe vessel with: a body defining an interior region; a first intake port in fluid connection with the interior region; an sample port aligned with the first intake port such that a probe extending through the interior region passes through the sample port; and an evacuation valve coupled to a second intake port, an exhaust port, and the interior region of the body, the evacuation valve having a first position providing fluid connection between the second intake port and the exhaust port and a second position providing fluid connection between the second intake port and the interior region of the body.

In some embodiments, the evacuation valve includes a three-way valve.

In some embodiments, the system includes a seal limiting fluid flow through the first intake port. In some cases, the seal includes a screw cap with septum.

In some embodiments, the system includes an atmospheric solids analysis probe inserted through the septum.

In some embodiments, the system includes an ionization system coupled to the sample port. In some cases, the system includes a mass spectrometer coupled to the ionization system.

In some embodiments, the system includes a seal limiting fluid flow through the sample port. In some cases, seal comprises a plug.

Some methods of ionization sampling include: connecting an inert gas line to a first intake port of a probe vessel via a valve; purging the inert gas line with the valve in a first valve position, the first valve position isolating the inert gas line from the first intake port of the probe vessel; purging an interior region of the of the probe vessel with the valve in a second valve position, the second valve position fluidly coupling the inert gas line to the first intake port of the probe vessel; inserting a capillary probe into a second intake port of the probe vessel; and coupling a sample port of the probe vessel to an ionization system.

In some embodiments, purging the interior region of the of the probe vessel comprises applying a positive fluid pressure.

In some embodiments, purging the interior region of the of the probe vessel comprises vacuum-less purging.

In some embodiments, inserting the capillary probe into the second intake port of the probe vessel comprises inserting the capillary probe into the second intake port of the probe vessel until the capillary probe extends out of sample port.

In some embodiments, methods include sampling a reaction vessel with the capillary probe with the valve in the second position after the step of purging an interior region of the of the probe vessel. In some cases, methods include sealing the sample port and placing the valve in the first position after sampling the reaction vessel. In some cases, methods include repeating the steps of purging the inert gas line and purging an interior region of the of the probe vessel after sealing the sample port and placing the valve in the first position after sampling the reaction vessel.

Probe vessels as described can facilitate the measurement (e.g., mass spectrometry analysis) of air sensitive substances that have to be under inert conditions. These probe vessels can avoid the need for use of a glove box. These probe vessels can be purged easily and efficiently using an inert gas supply without use of a vacuum pump. These probe vessels can also facilitate sample preparation directly from a reaction vessel.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a probe vessel engaged with an atmospheric solids analysis probe.

FIGS. 2A and 2B show the probe vessel of FIG. 1 from the opposite side of an evacuation valve of the probe vessel.

FIG. 3 is an exploded view of the probe vessel of FIG. 1.

FIGS. 4A and 4B are magnified views of the probe vessel connected to an ionization system.

FIG. 5 is a side view of the probe vessel connected to the ionization system with the atmospheric solids analysis probe fully inserted in an enclosure of the ionization system.

FIGS. 6A and 6B show components of the coupling system for connecting the atmospheric solids analysis probe to the ionization system.

Like reference symbols in the various drawings indicate like elements.

### DETAILED DESCRIPTION

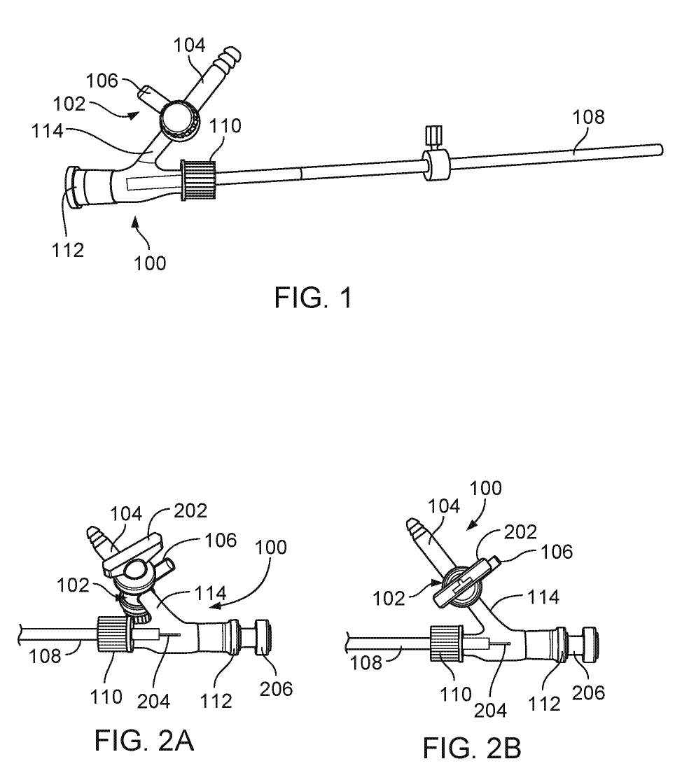

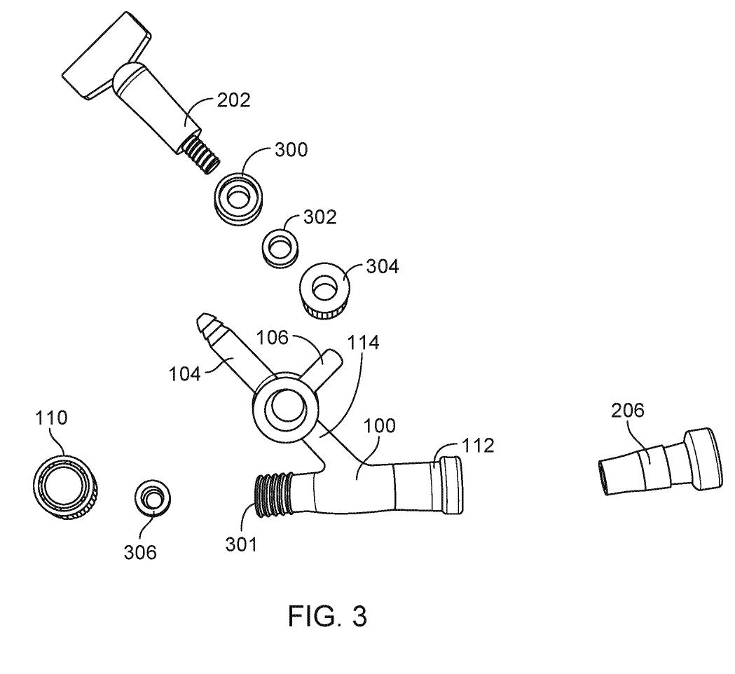

FIG. 1 shows a probe vessel 100 engaged with an atmospheric solids analysis probe 108. As discussed further herein, the probe vessel 100 is configured to facilitate providing a pure passageway for a sample to be introduced into an ionization system, including an ionization source such as the one described in U.S. Pat. No. 7,977,629, entitled “ATMOSPHERIC PRESSURE ION SOURCE PROBE FOR A MASS SPECTROMETER,” which is incorporated by reference herein in its entirety. The probe vessel 100 includes a body defining an interior region. The probe vessel also includes a first intake, sample inlet 301 (shown in FIG. 3). A removable sealing mechanism is coupled to the first intake to limit (e.g., prevent) fluid flow through the first intake. In the probe vessel 100, the sealing mechanism is a screw cap 110 with a sealing septum. The screw cap 110 is configured to receive the atmospheric solids analysis probe 108 in a sealed manner through the first intake. The screw cap 110 allows the capillary holder of the atmospheric solids analysis probe 108 to be inserted into the probe vessel 100 through the sample inlet 301 with an airtight lead. Other probe vessels use other sealing mechanisms which are configured to seal around the atmospheric solids analysis probe 108.

The probe vessel 100 also includes a second intake, inert gas intake 114. A valve 102, here a 3-way valve, is coupled to the inert gas intake 114. As discussed further herein, the valve 102 permits an inert gas line to be purged or evacuated of air before the inert gas line is placed in fluid communication with the probe vessel 100 and before the inert gas contacts a sample maintained in the atmospheric solids analysis probe 108. The valve 102 includes an inert inlet 104 and an inert line exhaust 106. The three-way valve facilitates purging the probe vessel without use of a vacuum pump. Some probe vessels incorporate valves with more than three connections.

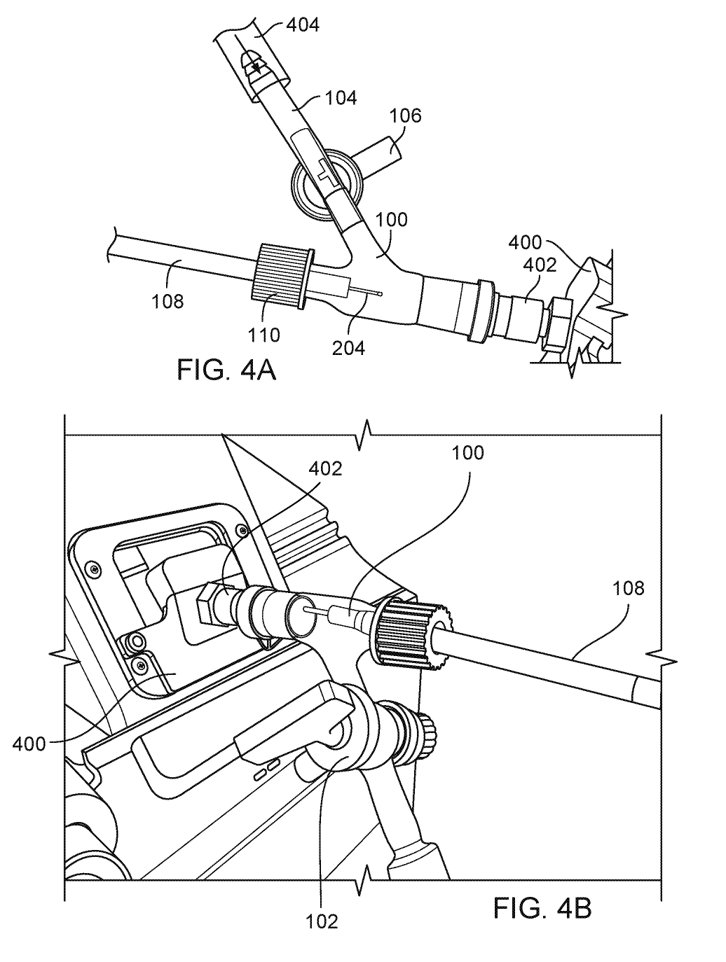

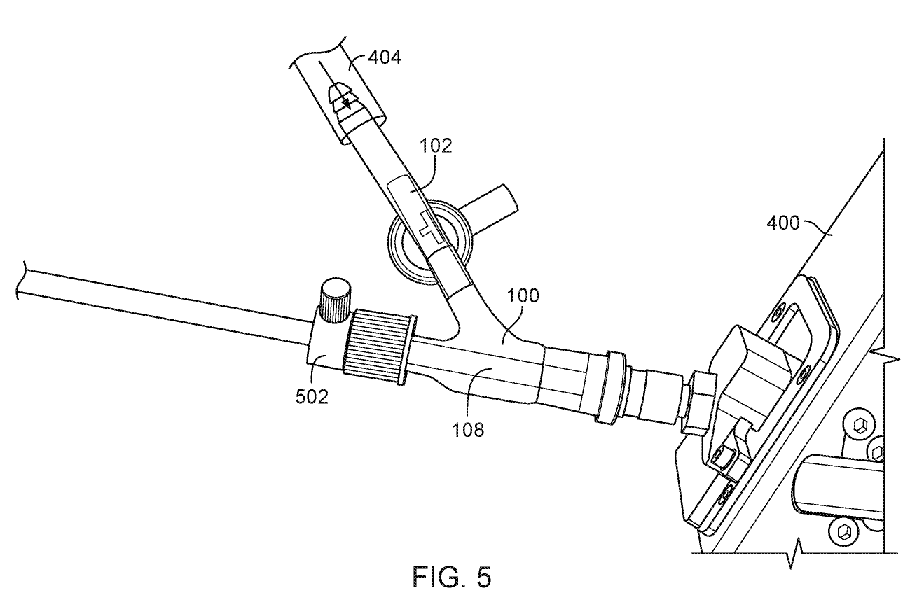

FIGS. 2A and 2B show the probe vessel of FIG. 1 from the opposite side of an evacuation valve of the probe vessel. As demonstrated in FIGS. 2A and 2B, the valve 102 is controlled via a stopcock 202. The stopcock 202 is actuated to change the direction of fluid flowing through the valve 102. For example, in a first position, the stopcock 202 causes fluid introduced via inert inlet 104 to be exhausted through the inert line exhaust 106. In a second position, stopcock 202 causes fluid introduced via inert inlet 104 to be exhausted into the inert gas intake 114 of the probe vessel 100. The long side of the marking on the stopcock (see FIGS. 2B, 4A and 5) indicates whether the valve 102 is positioned to provide a fluid connection between the inert inlet 104 and the inert line exhaust 106 (see FIG. 2B) or to provide a fluid connection between the inert inlet 104 and the inert gas intake 114 (see FIGS. 4A and 5).

In FIGS. 2A and 2B, the stopcock 202 is in the position that causes the fluid introduced via inert inlet 104 to be exhausted through the inert line exhaust 106, for example to purge air contained in the inert gas line and prevent poisoning the sample contained on the capillary 204. The inert gas provided via the inert gas intake is configured to maintain a sample contained on capillary 204 of the atmospheric solids analysis probe 108 in a particular state for ionization. The probe vessel 100 includes a plug 206 positioned in a sample port 112 of the probe vessel 100. Before use, the probe vessel 100 can be purged of air using an inert gas provided through the inert inlet 104. The sample port 112 is aligned with the sample inlet 301 such that a probe (e.g., the atmospheric solids analysis probe 108) inserted through the sample inlet 301 passes through the sample port 112 if pushed far enough.

FIG. 3 is an exploded view of the probe vessel of FIG. 1. In FIG. 3, the screw cap 110 is removed from the first inlet, sample inlet 301, of the probe vessel 100. As demonstrated in FIG. 3, the screw cap 110 includes a membrane 306 that assists with maintaining a sealed connection upon entry of the atmospheric solids analysis probe and sample through the screw cap 110. Portions of the valve 102 are also removed. In particular, the valve body 300, an o-ring 302, and adjuster 304 are removed from the probe vessel 100. Additionally, FIG. 3 shows the plug 206 removed from the sample port 112.

FIGS. 4A and 4B are magnified views of the probe vessel connected to an ionization system. FIG. 4A is a side view of the probe vessel 100 connected to an ionization system 400 via connector 402. FIG. 4B is a perspective view of the probe vessel 100 connected to the ionization system 400. FIGS. 4A and 4B illustrate an inert gas line 404 connected to the inert inlet 104. In FIG. 4A, the capillary 204 containing the sample of the atmospheric solids analysis probe 108 is in an intermediate position in the probe vessel 100.

FIG. 5 is a side view of the probe vessel connected to the ionization system with the atmospheric solids analysis probe fully inserted in an enclosure of the ionization system. As demonstrated in FIG. 5, the atmospheric solids analysis probe 108 is inserted fully into the probe vessel 100, such that the capillary 204 and the sample contained therein are positioned into an enclosure of the ionization system 400 for ionization and measurement. The atmospheric solids analysis probe 108 includes a stop 502 limiting the travel of the atmospheric solids analysis probe 108 into the probe vessel 100 and the ionization system 400. Once the atmospheric solids analysis probe 108 is inserted into the ionization system 400, the sample may be analyzed. The probe vessel 100 has demonstrated the ability to successfully provide samples to the ionization system 400 without the use of a vacuum system.

In use, the atmospheric solids analysis probe 108 is inserted through the screw cap 110 with the valve 102 in the position shown in FIGS. 2A and 2B. The probe vessel 100 is attached to the inert gas line 404 with the valve 102 still in the position shown in FIGS. 2A and 2B. Inert gas is used to purge the portion of the valve 102 that was exposed to the surrounding atmosphere without use of a vacuum pump. After purging, the valve 102 is moved to a position where the inert gas supplied via the inert gas line 404 is in fluid communication with the probe vessel 100 as shown in FIGS. 4A and 5. The plug 206 is removed and samples can be taken directly out of a reaction vessel or another sample-containing vessel in counter-flow without need for a glove box for sample preparation. The plug 206 is used to close the sample port 112 and the valve 102 is returned to the position shown in FIGS. 2A and 2B to place the probe vessel 100 in transport mode. For analysis, the steps used for pre-sampling purging are repeated before the plug 206 is removed and the probe vessel 100 is attached to ionization system 400 while the gas source provides a counter-flow of inert gas.

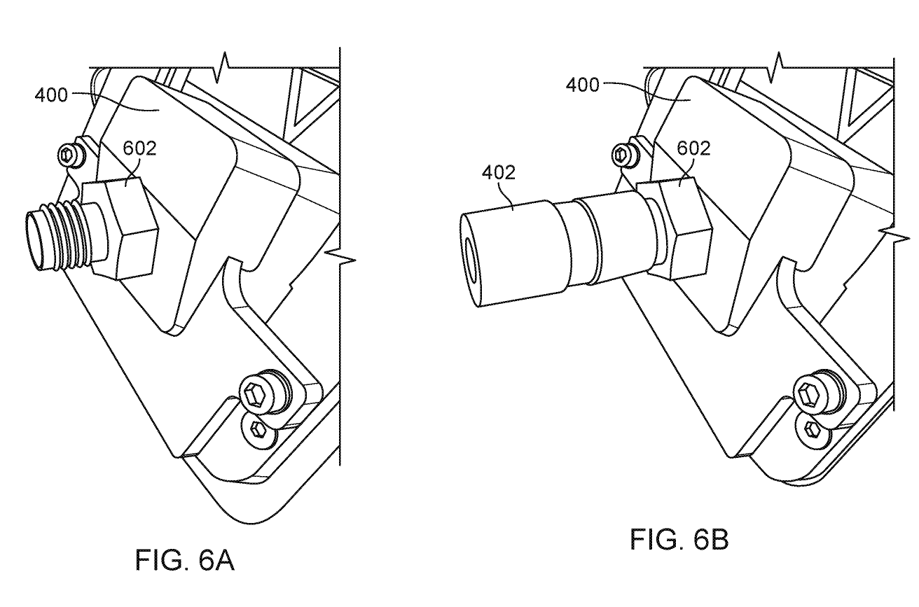

FIGS. 6A and 6B show components of the coupling system for connecting the atmospheric solids analysis probe to the ionization system. As demonstrated in FIG. 6, the connector can be a two-fold coupling including ionization system joint 602 and connector 402 configured to receive the shaft of the atmospheric solids analysis probe 108.

Implementations of the subject matter and the operations described in this specification can be implemented by digital electronic circuitry, or via computer software, firmware, or hardware, including the structures disclosed in this specification and their structural equivalents, or in combinations of one or more of them. For example, the purging process may be electronically controlled via one or more pumps, one or more actuators coupled to a valve, and or one or more sensors configured to sense a parameter or condition in the probe vessel, the ionization system, or the mass spectrometer and provide feedback for controlling purging. Implementations of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Implementations of the subject matter described in this specification can be implemented in a computing system that includes a back end component, e.g., as a data server, or that includes a middleware component, e.g., an application server, or that includes a front end component, e.g., a user computer having a graphical display or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary implementations, and that such variations are intended to be encompassed by the present disclosure. It is recognized that features of the disclosed implementations can be incorporated into other disclosed implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. An ionization sampling system comprising:
a probe vessel comprising:
a body defining an interior region;
a first intake port in fluid connection with the interior region;
an sample port aligned with the first intake port such that a probe extending through the interior region passes through the sample port; and
an evacuation valve coupled to a second intake port, an exhaust port, and the interior region of the body, the evacuation valve having a first position providing fluid connection between the second intake port and the exhaust port and a second position providing fluid connection between the second intake port and the interior region of the body.

2. The system according to claim 1, wherein the evacuation valve comprises a three-way valve.

3. The system according to claim 1, comprising a seal limiting fluid flow through the first intake port.

4. The system according to claim 3, wherein the seal comprises a screw cap with septum.

5. The system according to claim 1, further comprising an atmospheric solids analysis probe inserted through the septum.

6. The system according to claim 1, further comprising an ionization system coupled to the sample port.

7. The system according to claim 5, further comprising a mass spectrometer coupled to the ionization system.

8. The system according to claim 1, further comprising a seal limiting fluid flow through the sample port.

9. The system according to claim 7, further comprising wherein the seal comprises a plug.

10. A method of ionization sampling comprising:
connecting an inert gas line to a first intake port of a probe vessel via a valve;
purging the inert gas line with the valve in a first valve position, the first valve position isolating the inert gas line from the first intake port of the probe vessel;
purging an interior region of the of the probe vessel with the valve in a second valve position, the second valve position fluidly coupling the inert gas line to the first intake port of the probe vessel;
inserting a capillary probe into a second intake port of the probe vessel; and
coupling a sample port of the probe vessel to an ionization system.

11. The method of claim 10, wherein purging the interior region of the of the probe vessel comprises applying a positive fluid pressure.

12. The method of claim 10, wherein purging the interior region of the of the probe vessel comprises vacuum-less purging.

13. The method of claim 10, wherein inserting the capillary probe into the second intake port of the probe vessel comprises inserting the capillary probe into the second intake port of the probe vessel until the capillary probe extends out of sample port.

14. The method of claim 10, comprising sampling a reaction vessel with the capillary probe with the valve in the second position after the step of purging an interior region of the of the probe vessel.

15. The method of claim 14, comprising sealing the sample port and placing the valve in the first position after sampling the reaction vessel.

16. The method of claim 15, comprising repeating the steps of purging the inert gas line and purging an interior region of the of the probe vessel after sealing the sample port and placing the valve in the first position after sampling the reaction vessel.
